(19) United States
(12) Patent Application Publication
(10) Pub. No.: US 2026/0123628 A1
(43) Pub. Date: May 7, 2026

(54) NATURAL OIL-BASED WATER SOLUBLE BIOCIDE

(71) Applicant: Florida Biotech, LLC, Tampa, FL (US)

(72) Inventor: Joseph ANTOUN, Tampa, FL (US)

(73) Assignee: Florida Biotech, LLC, Tampa, FL (US)

(21) Appl. No.: 19/058,174

(22) Filed: Feb. 20, 2025

Related U.S. Application Data
(63) Continuation of application No. 18/937,329, filed on Nov. 5, 2024.

(51) Int. Cl. A01N 37/16; A01N 25/04; A01N 25/30; A01P 3/00

(52) U.S. Cl. CPC A01N 37/16; A01N 25/04; A01N 25/30; A01P 3/00

(57) ABSTRACT

A biocidal agent includes a natural oil-derived aliphatic fatty-acid chain and at least one quaternary ammonium salt moiety at one end of the natural oil-derived aliphatic fatty-acid chain. A non-ionic surfactant is bonded to each of the at least one quaternary ammonium salt moiety to form a liphophilic core with polar extremities to form a self-emulsified water-soluble biocidal agent. The synthetized green, biocompatible compound showed Log 6 reduction of Gram+, Gram−, yeast and fungus microbial organisms.

### TECHNICAL FIELD

The present disclosure relates generally to biocides, and more particularly to a biocompatible water soluble biocide.

### BACKGROUND

Microbial infections induced through bacterial adhesion and colonization on hard non-porous surfaces of medical devices are one of the main complications of using such devices, as they can cause high rates of mortality. The creation of biofilm on material surfaces triggers these bacterial infections. Since the first synthesis of penicillin in 1928, various new antibiotics have been developed for remedying microbial infections, owing to its great bactericidal action and minimal toxicity to mammalian cells. Considering that the growth rate of new antimicrobial drugs can barely keep up with the advancement of bacterial resistance, it is becoming progressively clear that the “post-antibiotic era” is on the horizon. Annually, more than 700,000 patients pass away due to drug-resistant germs. As a result, there is a vital requirement to generate new antibacterial biomaterials to enhance bacterial selectivity and lessen antibiotic resistance.

Therefore, the prevention of bacterial attachment and the subsequent formation of biofilms on these surfaces is important. Biomaterials play an essential function in disease treatment and healthcare improvement. The diversity, function, and wide variety of biomaterials employed worldwide have improved considerably in recent years. Nevertheless, the attachment of harmful microorganisms to biomaterial surfaces, leading to biofilm growth, continues to be a major issue that seriously restricts the functional use of these systems. Various strategies have been developed to reduce the exposure of medical devices to bacterial colonization, biofilm formation and infections. Traditionally, two approaches have been widely utilized to fight against microorganisms: passive defense through using fouling resistant coatings, which can prevent the initial attachment of bacteria to a material over a short period of time; and active attack via incorporation of antimicrobial agents, including polycations, nanoparticles, enzymes, and antibiotics to kill the attached bacteria.

For example, work has been done to develop an antibacterial polyurethane coating from soybean oil-based polyol with built-in quaternary ammonium salt functionalities. Similar work has been conducted to prepare antibacterial waterborne polyurethanes derived from soybean oil and quaternary ammonium salts containing chain extenders and castor oil-based polyurethane coatings utilizing quaternized triethanolamine chain extenders. The application of vegetable oil-based polyurethane has also been extended to other biomedical applications such as wound dressing, cardiac patches and tissue engineering.

However, several drawbacks of these strategies limit the practical application of them. Without biocidal activity, the passive defense mechanisms are only partially effective for preventing bacterial adhesion. Once the minimum number of bacteria adheres to the surface, they can quickly grow and form a stable biofilm. On the other hand, although the active attack agents effectively prevent the formation of viable biofilms on surfaces, they often require high levels of toxicity for being effective and also suffer from problems relating to their improper biocompatibility, leaching out from the surface, short periods of biocidal activity, and the development of bacterial resistance.

### SUMMARY

Accordingly, a new generation of biobased, biocompatible, effective and reactive water soluble biocidal agents is disclosed herein. The new water soluble compounds can replace the current chlorine, hydrogen peroxide, alcohol and quaternary ammonium disinfectant molecules used in current biocidal products which show many secondary effects and have high toxicity. That is, the preparation of stable surface active biobased antibacterial/biocidal agents are described herein. Such biocidal agents can adhere effectively to bacteria while also killing all types of bacteria without concern for bacterial resistance, solving the disadvantages of the current approaches, such as increased bacterial resistance induced through impregnation of additives such as antibiotics, metallic nanoparticles, N-halamines, and quaternary ammonium salts (QAS). Moreover, in contradiction to the existing compounds, the biocidal agents described herein are biocompatible, have low toxicity, and are biodegradable, therefore having a low carbon fingerprint on the environment.

As a non-limiting example, biocidal, biocompatible, water-soluble, and dispersible soybean oil-based components for various biomedical applications are disclosed. The intended biocidal materials not only have proper biocidal activity against Gram-positive bacteria, Gram negative bacteria, and fungi and yeast but will also be water soluble and could be used as a new generation of safe, green, and bio-based antimicrobial agents.

For example, a water soluble siloxane cross-linked soybean oil-based network with built-in urethane linkages generated through the non-isocyanate method and quaternary ammonium salts, chemically anchored to the coating backbone is described. That is, preparation of siloxane decorated soybean oil component with built-in quaternary ammonium salts moieties and long hydrophobic counterpart by employing hydrocarbon fatty acid chain from soybean oil as reactive biocide agent is described. The biocidal activity efficacies in conjunction with mechanisms of various aliphatic carbon structure of such compounds against microorganisms is deployed to optimize the bioactive spectrum of such new soybean biobased molecules.

Additionally, a method of synthesizing such a biocidal compound is provided. The method starts with soybean oil and includes synthesizing and characterizing a tertiary amine functional soybean oil intermediate. The method then includes a single step quaternization and providing two quaternary moieties in one reaction step. Alternatively or additionally, the simultaneous introduction of QAS and alkoxysilane on the intermediated soybean oil derivatives is done. The method then includes the protection of alkoxy silane moieties and solubilization in water.

The tethering of such biocide moieties and hydrophobic parts donates the intended material to proper self-water solubility and biocidal activity. The concentration and position of the ionic group towards the length of the hydrophobic counterpart is optimized to achieve the balance of biocidal activity and water solubility (HLB), stability and anchoring properties (polarity) on any type of hard non-porous surface.

According to an aspect of this disclosure, a biocidal agent includes a natural oil-derived aliphatic fatty-acid chain, at least one quaternary ammonium salt moiety at one end of the natural oil-derived aliphatic fatty-acid chain, and a non-ionic surfactant bonded to each of the at least one quaternary ammonium salt moiety to form a liphophilic core with polar extremities to form a self-emulsified water soluble biocidal agent.

According to an embodiment of any paragraph(s) of this disclosure, the non-ionic surfactant includes 6 to 8 moles of ethylene oxide.

According to an embodiment of any paragraph(s) of this disclosure, the natural oil-derived aliphatic fatty-acid chain is a soybean oil-based aliphatic fatty-acid chain.

According to an embodiment of any paragraph(s) of this disclosure, the wherein the natural oil-derived aliphatic fatty-acid chain is a canola oil-based aliphatic fatty-acid chain.

According to another aspect of this disclosure, a biocidal agent includes a soybean oil-derived aliphatic fatty-acid chain, at least one quaternary ammonium salt moiety at one end of the soybean oil-derived aliphatic fatty-acid chain, and a non-ionic surfactant bonded to each of the at least one quaternary ammonium salt moiety to form a liphophilic core with polar extremities to form a self-emulsified water soluble biocidal agent.

According to an embodiment of any paragraph(s) of this disclosure, the non-ionic surfactant includes 6 moles of ethylene oxide.

According to another aspect of this disclosure, a method of producing a biocidal agent includes the steps of providing a functionalized natural oil-derived fatty-acid derivative, providing at least one quaternary ammonium salt moiety and at least one siloxane moiety on a functionalized end of the functionalized natural oil-derived fatty acid derivative, and binding a non-ionic surfactant to each of the at least one quaternary ammonium salt moiety to form a lipophilic core with polar extremities to form a self-emulsified water soluble biocidal agent.

According to an embodiment of any paragraph(s) of this disclosure the providing a functionalized natural oil-derived fatty-acid derivative includes providing a natural oil-derived fatty-acid and functionalizing the natural oil-derived fatty-acid.

According to an embodiment of any paragraph(s) of this disclosure, the natural oil-derived fatty-acid is derived from soybean oil.

According to an embodiment of any paragraph(s) of this disclosure, the functionalizing the soybean oil includes epoxidizing the soybean oil, the functionalized natural oil-derivative being epoxidized soybean oil.

According to an embodiment of any paragraph(s) of this disclosure, the functionalizing the natural oil-derived fatty acid derivative includes at least one of amidation, transesterification, and carbonization.

According to an embodiment of any paragraph(s) of this disclosure, the method further includes solubilizing the biocidal agent in water.

The following description and the annexed drawings set forth in detail certain illustrative embodiments described in this disclosure. These embodiments are indicative, however, of but a few of the various ways in which the principles of this disclosure may be employed. Other objects, advantages and novel features will become apparent from the following detailed description when considered in conjunction with the drawings.

### BRIEF DESCRIPTION OF DRAWINGS

The annexed drawings show various aspects of the disclosure.

FIG. 1A is the chemical structure of Bis-(TriMethoxy silyl, amide) of Soybean oil diester.

FIG. 1B is the chemical structure of a quaternary ammonium salt containing fatty amide molecule with reactive aloxane moiety.

FIG. 1C is the chemical structure of an exemplary biocidal agent.

FIG. 2 is schematic illustration of the epoxidation of soybean oil into epoxidized soybean oil.

FIG. 3A is the chemical structure of 1,6-Dichlorohexane.

FIG. 3B is the chemical structure of 1,8-Dichlorooctane.

FIG. 3C is the chemical structure of 1,10 Dichlorodecane.

FIG. 3D is the chemical structure of 4-Chloro-1-butanol.

FIG. 3E is the chemical structure of 1,4-Dichlorobutane.

FIG. 4A is the chemical structure of 3-(dimethylamino)-1-propylamine (DMPA).

FIG. 4B is the chemical structure of 3-(Diethylamino)propylamine (DEPA).

FIG. 4C is the chemical structure of N,N-Dimethylethylenediamine.

FIG. 4D is the chemical structure of 3-Dimethylamino-1-propanol.

FIG. 4E is the chemical structure of 4-dimethylaminobutylamine.

FIG. 4F is the chemical structure of 3-(Dibutylamino)propylamine.

FIG. 4G is the chemical structure of N,N,N′,N′-Tetraethyl-1,3-propanediamine.

FIG. 4H is the chemical structure of N,N,N′,N′-Tetramethyl-1,4-butanediamine.

FIG. 4I is the chemical structure of N,N,N′,N′-Tetraethyldiethylenetriamine.

FIG. 4J is the chemical structure of Tri-ethanol amine.

FIG. 4K is the chemical structure of Tri-Ethyl amine.

FIG. 5A is the chemical structure of (3-aminopropyl) trimethyoxysilane (APS).

FIG. 5B is the chemical structure of (3-Chloropropyl) Trimethoxysilane (CPTMS).

FIG. 6A is the chemical structure of tetrabutylammonium bromide (TBAB).

FIG. 6B is the chemical structure of methyl ethyl ketone (MEK).

FIG. 6C is the chemical structure of tetrahydrofuran (THF).

FIG. 6D is the chemical structure of Ethyl acetate.

FIG. 6E is the chemical structure of triethanol amine.

FIG. 6F is the chemical structure of propylene glycol.

FIG. 7 is a schematic flowchart of an exemplary method of producing a biocidal agent.

### DETAILED DESCRIPTION

Biobased, biocompatible, effective and reactive water soluble biocidal agents are disclosed herein which have low toxicity and are biodegradable, having a low carbon fingerprint on the environment. Specifically, the biocidal agents include a natural oil-derived aliphatic fatty-acid chain, at least one quaternary ammonium salt moiety at one end of the natural oil-derived aliphatic fatty-acid chain, and a non-ionic surfactant bonded to each of the at least one quaternary ammonium salt moiety. The biocidal agents therefore form a lipophilic core with polar extremities to form a self-emulsified water-soluble biocidal agent.

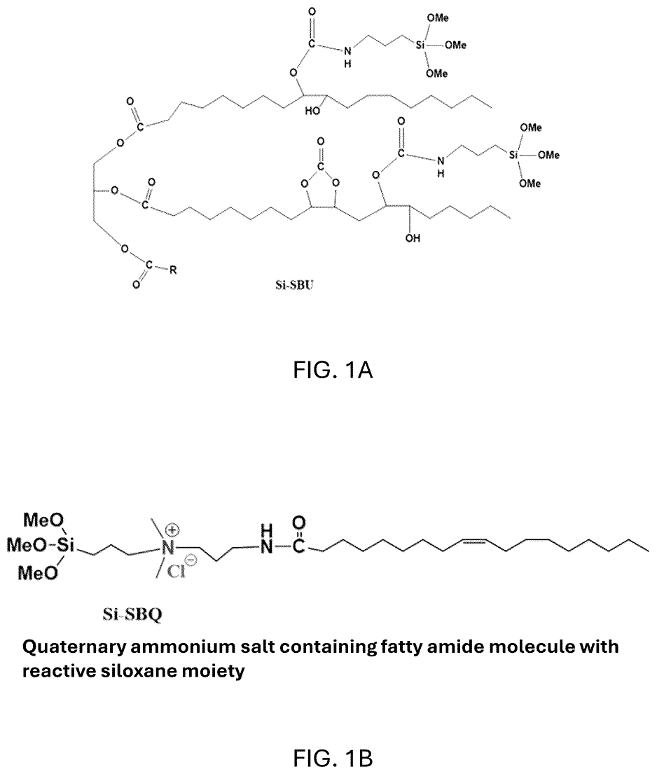

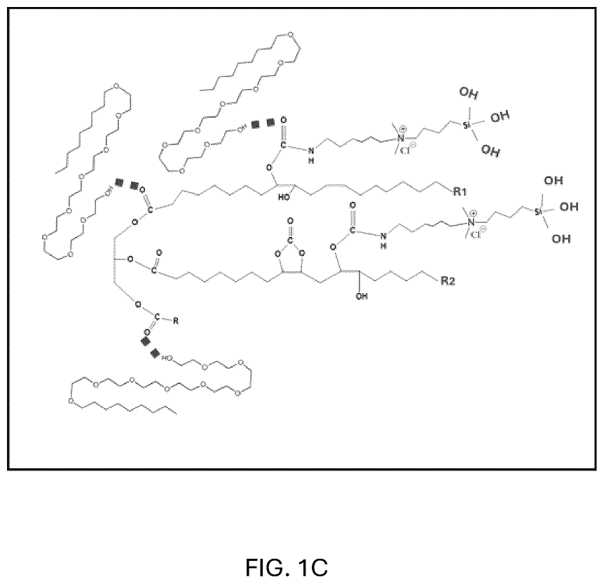

As a non-limiting example, a water-soluble siloxane cross-linked soybean oil-based network with built-in urethane linkages generated through the non-isocyanate method and quaternary ammonium salts, chemically anchored to the coating backbone is described herein. FIG. 1A, depicts Methoxy-silane functionalized soybean oil as an exemplary natural oil derivative. That is, FIG. 1A represents the structure of an exemplary biocidal agent synthetized from one epoxy derivative of soybean oil before adding any quaternary ammonium fragment to the aliphatic chain thereof. FIG. 1B depicts siloxane decorated soybean oil component including the built-in quaternary ammonium salts moieties and long hydrophobic counterpart by employing hydrocarbon fatty acid chain from soybean oil as the resultant reactive biocide agent. That is, FIG. 1B represents an exemplary complete functionalized aliphatic chain of the natural oil which includes: (a) the aliphatic chain of the fatty acid, (b) an amide group, (c) a quaternary ammonium group, and (d) a tri-methoxy-silyl extremity. The general chemical structure of the resultant water-soluble biocidal agent is depicted in FIG. 1C. The ionic forces and interactions of the solubilizer used with the polar group of the main compound that constitutes a hydrophilic external coat of the main hydrophobic core makes the biocidal agent soluble in water. The biocidal activity efficacies in conjunction with mechanisms of various aliphatic carbon structure of such compounds against microorganisms optimizes the bioactive spectrum of such new soybean biobased molecules.

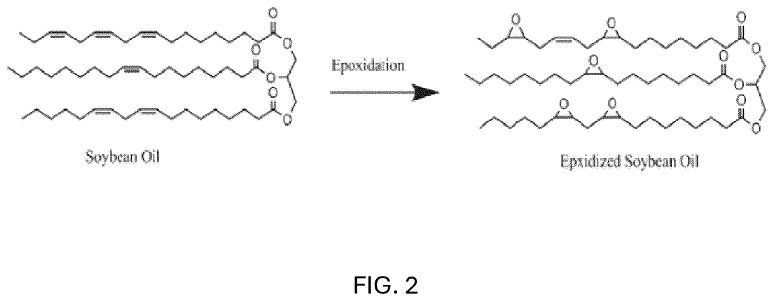

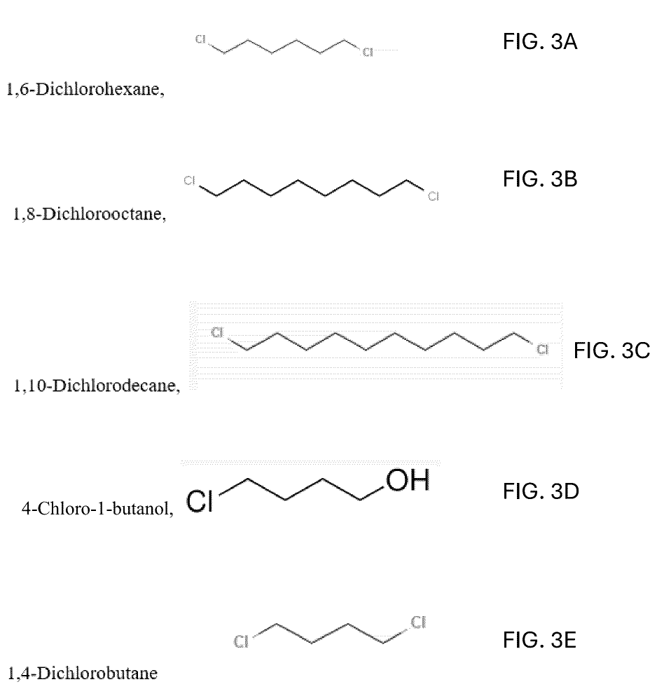

Additionally, a method of preparing such a biocidal agent is provided. The method includes first preparing a functionalized natural oil through a green method. Specifically, functionalizing the natural oil includes introducing a proper and reactive focal group on the backbone of the natural oil structure. For example, soybean oil (SBO) may be epoxidized by converting the unsaturated bond to a polar epoxy group, as can be seen in FIG. 2, to introduce a suitable functional group to insert proper moieties on its structure. The resulting epoxidized SBO may therefore have a molecular weight of about 1000 g/mol and epoxy content of 3.47 mmol epoxy/g. SBO may, however, be functionalized with suitable functional group based on a different synthetic strategy. For example, other functionalization such as amidation, transesterification, carbonization and others may be applied to similarly introduce proper polar and functional groups on the natural oil. Additionally, it is understood that natural oils other than SBO, such as canola oil, castor oil, sunflower oil, seed oil, coconut oil, pine oil, jojoba oil, grapeseed oil, almond oil, shea butter, rosehip seed oil, argan oil, marula oil, olive oil, neem oil, and others may be used. That is, all kinds of natural oils may be explored and assessed on behalf of their chemical structure and precisely the length of their aliphatic chain, the number of ramifications in their structure, the degree of unsaturation, and their levels of biocompatibility. As depicted in FIGS. 3A-E, other suitable hydrocarbon backbones may include at least one of 1,6-Dichlorohexane, 1,8-Dichlorooctane, 1,10-Dichlorodecane, 4-Chloro-1-butanol, 1,4-Dichlorobutane. The hydrocarbons are used as a solvent during the syntheses of the compounds, which includes an extension of the aliphatic chain, addition of functional moieties, and extraction and purification of the compound. The optional use of a variety of different oils and hydrocarbon backbones allows the biocidal agent to be used despite bacterial resistance, as it can be changed to accommodate any bacterial resistance that may develop.

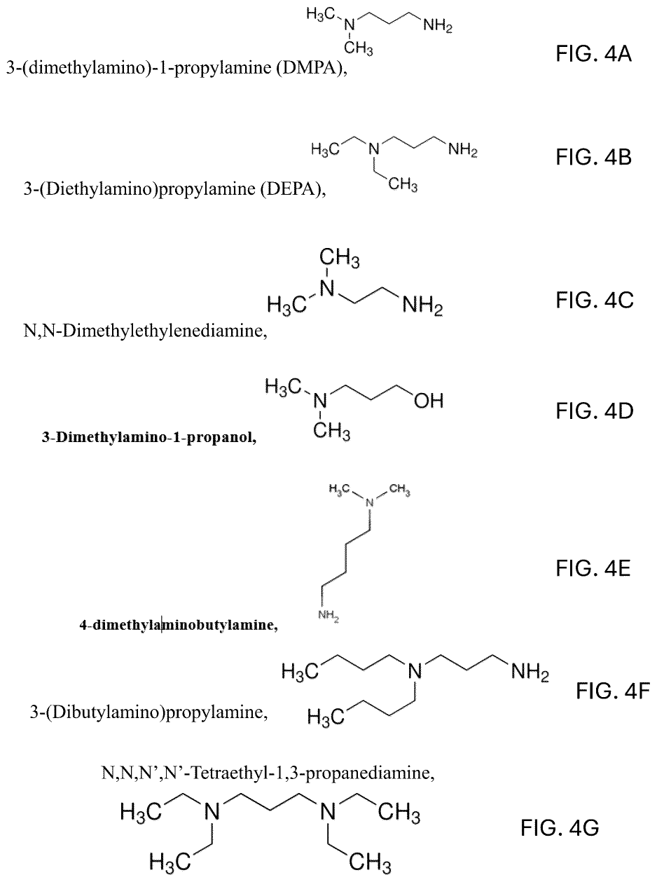

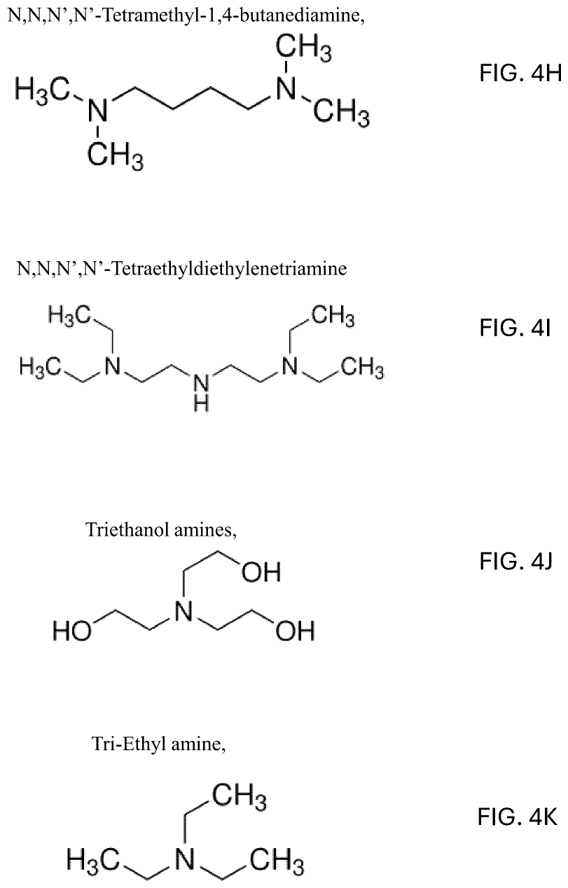

The functionalized natural oil is then used for the synthesis and characterization of a tertiary amine functional natural oil derivative. For example, a tertiary amine functional soybean oil intermediate may be synthesized. With reference to FIGS. 4A-J, the amines used may include at least one of 3-(dimethylamino)-1-propylamine (DMPA), 3-(Diethylamino)propylamine, N,N-Dimethylethylenediamine, 3-Dimethylamino-1-propanol, 4-dimethylaminobutylamine, 3-(Dibutylamino)propylamine, N,N,N′,N′-Tetraethyl-1,3-propanediamine, N,N,N′,N′-Tetramethyl-1,4-butanediamine, N,N,N′,N′-Tetraethyldiethylenetriamine, triethanol amines, trirthyl amine. The amines are selected depending on the chemical structure of the main natural oil used, as well as the stereospecific group added in order to avoid any steric hindrance of the molecule.

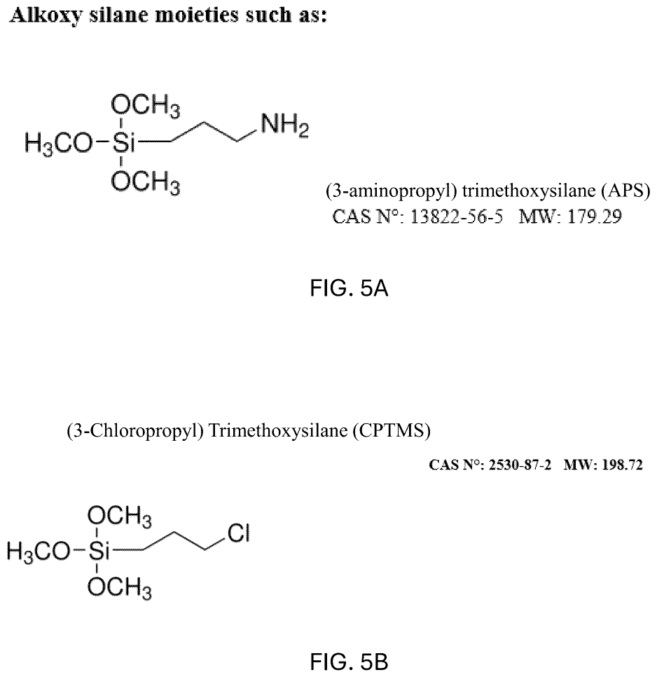

The method then includes a single step quaternization and providing two quaternary moieties in one reaction step. Alternatively or additionally, the simultaneous introduction of quaternary ammonium salt and alkoxy silane moieties on the intermediated natural oil derivatives is accomplished. FIGS. 5A-B depict exemplary alkoxy silane moieties that may be introduced. Specifically, suitable alkoxy silane moieties may include at least one of (3-aminopropyl) trimethoxysilane (APS), CAS N°: 13822-56-5, MW: 179.29; and (3-Chloropropyl) trimethoxysilane (CPTMS), CAS N°: 2530-87-2, MW: 198.72. Other derivatives such as ethoxy silane or hydroxy silane may also be used.

The method then includes the protection of the quaternary ammonium salt and/or alkoxy silane moieties and solubilization of the biocide agent in water. Specifically, the tethering of such biocide moieties and hydrophobic parts (functionalized natural oil derivative intermediate) donates the intended material for the biocide agent to properly self-water solubilize and provide the intended biocidal activity. The concentration and position of the ionic group towards the length of the hydrophobic counterpart is optimized to achieve the balance of biocidal activity and water solubility (HLB), stability and anchoring properties (polarity) on any type of hard non-porous surface.

Specifically, for example, based on the theoretical HLB values of the eventual synthetized compound, an anhydrous liquid surface active agent produced by the reaction of an alcohol with 6 moles of ethylene oxide may be chosen as a non-ionic surfactant. Such non-ionic surfactant is an excellent detergent for textile processing, metal degreasing, clay soils, fire-fighting, and industrial, institutional, and household cleaners due to its superb ability to penetrate, wet, solubilize, disperse, and emulsify. The properties of such non-ionic surfactant are depicted in Table 1 and Table 2, below. Due to its non-ionic structure, this product is compatible with anionic and cationic surfactants. In addition, it is stable in acidic and alkaline media.

TABLE 1
Typical Properties

| Appearance | Clear, Slightly Hazy Liquid |
|---|---|
| Activity | 99.7% min |
| Cloud Point (1% aq) | 50.5-54.0° C. (123-129° F.) |
| pH (1% aq) | 6.0-7.5 |
| Flash Point | 289° F. |
| Odor | Mild |
| Color (APHA) | 100 Max |
| Specific Gravity @ 25° C. | 0.984 |

TABLE 2

| | | | Test Method/ |
|---|---|---|---|
| | Value | Units | Conditions |
| Moles EO | 6.0 | — | — |
| Hydroxyl Value | 126-138 | mgKOHg | — |
| HLB Value | 12.4 | — | — |
| Activity | min. 99.7 | % | — |
| Cloud Point (1% | 50.5-54 | ° C. | — |
| Aqueous) | | | |
| Pour Point | 43.0 | ° F. | — |
| pH (1% Aqueous) | 5-7.5 | | |
| Flash Point | 289.0 | ° F. | — |
| Color | max. 100 | — | APHA |
| Specific Gravity (at | 0.984 | — | — |
| 25° C.) | | | |

This product is mixed with the functionalized natural oil based derivative intermediate (e.g., siloxane cross-linked soybean oil-based derivative) before adding any ionic force of any solvent, like water, to solubilize the compound. During the mixing in a non-aqueous media, all the hydrophobic moieties bind with each other to form a lipophilic core, while the polar or ionic groups are exposed and driven to the outlines of the compound. Afterwards, water is added gradually in order to solubilize the compound by interacting and forming hydrogen bonds with the polar extremities of the compound. The result is satisfactory. A clear solution is obtained from this compound solubilized in water. Samples were sent to microbiological laboritories to be tested against gram positive, gram negative, yeast and fungus microorganisms. The water-solution had a killing efficacy of Log 6 reduction at 0.3% satisfying the criteria of US EPA disinfection standard regulations as well as Canada Health regulatory requirements.

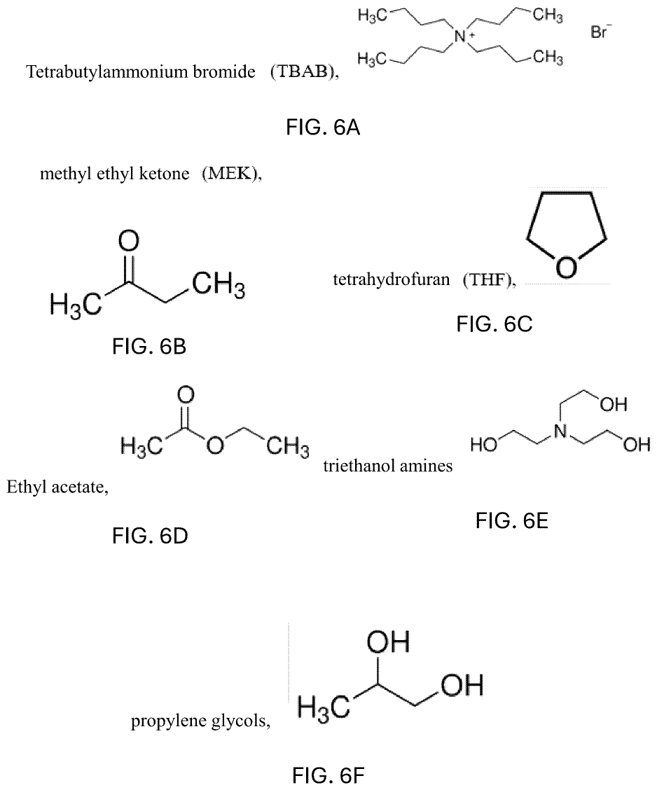

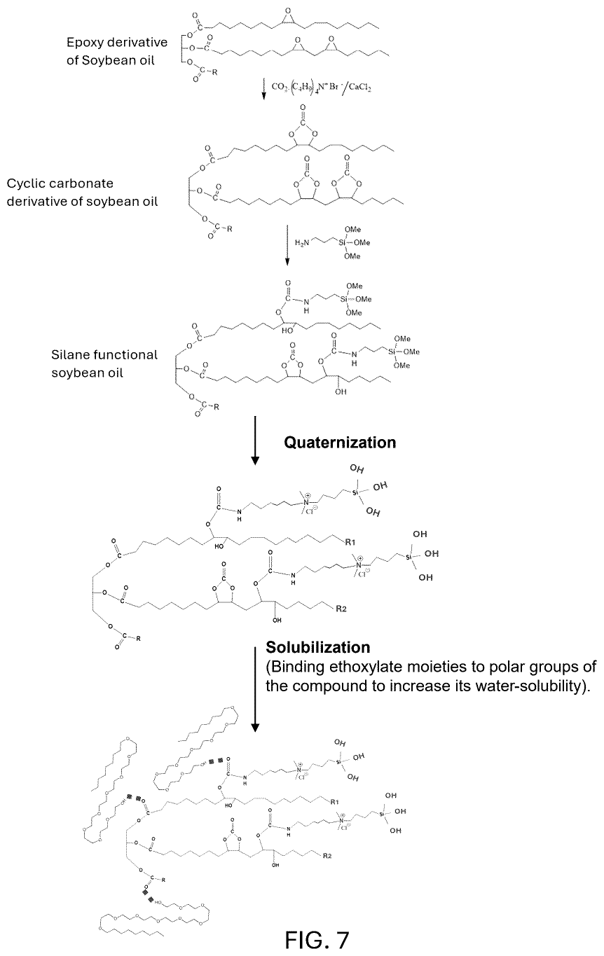

With reference to FIGS. 6A-F, other consumable chemicals and solvents used in the preparation of the biocidal agent may include at least one of tetrabutylammonium bromide (TBAB), methyl ethyl ketone (MEK), Ethyl acetate, propylene glycols, Tween 80, Tween 20, triethanol amines tetrahydrofuran (THF), calcium chloride (CaCl2), lithium chloride, sodium ethoxide, and diethyl ether. Gas: Carbon dioxide gas with a purity of 99.999%. N2 with high purity. FIG. 7 depicts a schematic flowchart of an exemplary method according to that described above.

The biocidal, biocompatible, water soluble and dispersible natural oil based components are applicable to a variety of biomedical applications. The biocidal agent has proper biocidal activity against Gram-positive bacteria, Gram-negative bacteria, yeast, mold and fungi. The biocidal agent may also have virucidal activities. The prepared biocidal agent is water soluble in all proportions and stable in time in aqueous solutions, and may therefore be applied as a new generation of safe, green and bio-based antibacterial agents with long-lasting contact active biocidal activity. The biocidal agent is produced without any hazardous chemical agents such as organic solvents (alcohol, aromatic cyclic compounds), heavy metals, chlorine derivatives, etc. The prevention of utilization of alcohols, organic species with the ability to release and leach out to the surrounding medium, and proper biocompatibility even at the biocidal dosage of biocide compounds is another advantage of the disclosed biocidal agent. Moreover, the biocidal agent and method of preparing the biocidal agent disclosed herein can be widely extended to many industries such as paint, carpets, ceramic, resin, fabrics, textiles, biomedical implants, dentistry and more.

EXAMPLE 1: The purpose of this Example is to show the bacterial activity of two samples (“Green Biocide #1” and “Green Biocide #2”) at two contact times (5 minutes and 10 minutes). The test procedure simulates the way in which the biocides are to be used.

### Summary of Results:

Test Carriers: Flat bottom glass carrier vials (20 mL). Number of carriers for control per lot of test item: 3. Number of carriers for test per lot of test item: 10.

Dilution: 1 part of test substance+15 parts of diluent (AOAC Synthetic Hard Water 200 ppm).

Test Organism: Staphylococcus aureus (ATCC 6538).

Contact Time: 5 minutes and 10 minutes.

Neutralizer: LLTS (Letheen broth+0.2% sodium Thiosulfate).

Exposure Temperature: 23±2° C.

Soil Load: The three-part soil load (0.5 g yeast extract, 0.5 g bovine serum albumin, 0.04 g bovine mucin in 10 mL phosphate buffer saline) based on ASTM E-2197-17². The soil load mixture given contains a level of protein roughly equal to that in 5% serum.

Efficacy Result: The performance standard for a confirmatory test is a mean LF≥6.0 for each lot of test substance (ES29 SYNOXY-PLUS DISINFECTANT CLEANER CONCENTRATE Lot #F010824-4, and F010824-5). The results met the performance requirements specified in the study plan/protocol and demonstrated complete inactivation of the test organism.

### Test System:

Test Microorganism: Staphylococcus aureus (ATCC #6538) was used as the microbial challenge. The strain was obtained by CREM Co Labs through Cedarlane Labs, Burlington, Ontario, the Canadian agent for the American Type Culture Collection (ATCC), Manassas, VA, USA. It is a Gram-positive, cocci-shaped bacterium frequently incriminated in healthcare-associated infections.

Bacterial Growth and Recovery Media: Trypticase Soy Broth was used for final test culture preparation of S. aureus. Trypticase Soy Agar (TSA) was used as a plating medium for carrier enumeration and recovery of S. aureus.

Preparation of Test Organism: To prepare the culture of Staphylococcus aureus, ASTM E2111-12 (2018) was used and, a stock culture stored in labelled cryovials at −80° C., was used for working culture preparation. 100 μL of thawed S. aureus was added to 10 mL of sterile Trypticase soy broth medium and the tube was incubated in the incubator at 35±2° C. for 18±2 hours.

Preparation of Test Inocula: In the efficacy test, performed on Green Biocide #1 & Green Biocide #2, the prepared test suspension A for efficacy test was used to prepare test suspension B for efficacy test by adding 160 μL of three-part soil load (0.5 g yeast extract, 0.5 g bovine serum albumin, 0.04 g bovine mucin in 10 mL phosphate buffer saline based on ASTM E-2197-17) to 340 μL of test suspension A for efficacy test.

### Test Method:

Preparation of Test Substances: The test substance was used without dilution (Ready-To-Use).

### Test Procedure:

Efficacy Test: Ten μL of the test suspension with three-part soil load was placed onto the inside bottom surface of each carrier by positive displacement pipette. The inoculum was dried on each carrier inside an operating biosafety cabinet (BSC) for up to 60 minutes or until visually dry, and then vacuum-dried in a desiccator for another 60 minutes. Three carriers as controls and three test carriers were used for each test sample and each contact time. After drying septate caps were removed and replaced by sterile regular caps in an aseptic condition to avoid contamination.

To assess bactericidal activity, the dried inoculum on each carrier was separately exposed to 1 mL of test item at its use-dilution for 5 minutes of exposure time. Each negative control carrier received 1 mL of PBST respectively instead, but otherwise treated in a manner identical to that for the test carriers. The carriers were held at 23° C.±2° C. during contact time.

Immediately at the end of the contact time, the test item was neutralized with 9 mL of neutralizer (Letheen broth+0.2% (w/v) sodium thiosulfate), and the mixture was passed through a 0.22 μm pore diameter membrane filter (47 mm diam.) after preparation of serial ten-fold dilutions in PBST to achieve countable colonies.

At the end of the testing, approximately 20 mL of the PBS-T and approximately 20 mL of the PBS used in the test was filtered using two separate membrane filters to assess reagent sterility.

Each membrane was individually placed on the surface of a Petri plate (100 mm in diam.) containing Trypticase soy agar plates and incubated anaerobically at 35±2° C. for 48±2 hours.

The colony forming units (CFU) on each plate will be counted. The CFU counts were used to determine log 10 reductions in the viability of the test organism by the test item.

Stability and Viability Controls: Viability Control: One dried inoculated but untreated carrier was treated with 10 mL neutralizer, vortex it very well and filtration was performed. Sterility Control: One sterile uninoculated carrier was treated with 10 mL neutralizer, vortex it very well and filtration was performed. Each membrane was individually placed on the surface of a Petri plate (100 mm in diam.) containing Trypticase soy agar plates and incubated anaerobically at 35±2° C. for 48±2 hours. The plates were observed for viability and contamination.

### Experimental Design:

### Preparation of Controls:

Purity of the Culture: For a valid test, the S. aureus. (ATCC #6538) culture was required to be pure with its typical morphology and colony color (small, circular, golden-colored, or white) and with no evidence for contamination. Culture purity check (isolation streak) was performed on one dilution of one carrier in efficacy test of each lot. The plate was incubated aerobically at 35±2° C. for 48±2 hours. Colonies from inoculum enumeration plates in neutralization validation test were also examined for morphology and characteristics of the test organism after incubation at 35±2° C. for 48±2 hours.

Sterility Controls on Other Test Articles: Controls were run to check the sterility of the carriers, neutralizer, PBS, and PBST as follows to check for sterility: For the TSA, two plates from each lot and 10 mL of neutralizer from each lot were incubated at 35±2° C. for a minimum of 5 days and examined for growth. A 2% of volume from PBS was passed separately through a membrane filter (0.22 μm pore diameter) and each membrane individually placed on a TSA plate (100 mm) and incubated at 35±2° C. for at least 5 days and examined for growth. On each day of test, two sterile, uninoculated carriers were placed into a tube of neutralizing subculture broth and the tube was incubated for 48±2 h at 35±2° C. Results were reported as + (growth), or − (no growth) as determined by presence or absence of turbidity. The acceptance criterion for the sterility controls was the complete absence of growth.

Growth Check Control: The TSA growth plates used in this study were tested for their ability to support the growth S. aureus by inoculating a plate by incubation at 35±2° C. for 48±2 h. The acceptance criterion was the presence of growth in the test culture media.

Efficacy Test: The test substance Green Biocide #1 & Green Biocide #2 were tested separately at each contact times (10 minutes and 10 minutes as follows for each lot: Number of carriers for each lot of test item: 3. Number of carriers for control per lot of test item: 3.

### Data Analysis:

Values with at least three significant figures were used when performing calculations. Log 10 reduction values were reported with two significant figures. Log 10 Density for each treated, and control carriers were calculated using the following formulation:

$${Log}_{10} \{ [ \frac{{\sum }_{i = 1}^{n} ( {Y}_{i} )}{{\sum }_{i = 1}^{n} ( {C}_{i} \times {D}_{i} )} ] \times V \}$$

Where: Y=CFU per filter; C=volume filtered; V=total volume of neutralizer; D=10-k; k=dilution; n=number of dilutions; i=lower limit of summation (the fewest number of dilutions).

The mean LD of three control carrier was calculated according to the following formula:

$$Mean LD = [ Log 10 ( carrier 1 ) + Log 10 ( carrier 2 ) + Log 10 ( carrier 3 ) ] / 3$$

The mean LD of Test carrier was calculated according to the following formula:

$$\begin{matrix}Mean LD = [ Log 10 ( carrier 1 ) + Log 10 ( carrier 2 ) + Log 10 ( carrier 3 ) + \\ Log 10 ( carrier 4 ) + Log 10 ( carrier 5 ) + Log 10 ( carrier 6 ) + Log 10 ( carrier 7 ) + Log 10 ( carrier 8 ) + Log 10 ( carrier 9 ) + Log 10 ( carrier 10 ) ] / 10\end{matrix}$$

Log Reduction (LR) for Test carriers were calculated according to the following formula:

$$LR = Mean LD ( Control Carriers ) - Mean LD ( Test Carriers )$$

Calculations were performed using a validated excel calculation sheet.

### Study Performance Control

Culture Purity Control: For a valid test, the test culture was required to show a pure culture of S. aureus with its typical morphology and colony color (small, circular, golden-colored, or white) with no evidence for contamination.

All sterility controls were also to be negative for a valid test.

There was to be readily visible growth of the test organism in all the inoculated culture media for the test to be considered as valid.

### The Test Item/Substance Performance Criteria

The applicable acceptance criteria for the performance of the test formulation and any test system control included were in accordance with the requirements of the target regulatory agency reviewing the data. In this study, the acceptance criteria include:

The mean LD must be at least 6.0 (corresponding to a geometric mean density of 1.0×10₆) and not above 7.0 (corresponding to a geometric mean density of 1.0×10₇) S. aureus; a mean LD below 6.0 or above 7.0 invalidates the test (refer to Section 19 Retesting guidance).

Sterility Control: Growth should not occur in any of the plates.

Viability Control: Growth should occur in the plates.

The performance standard for S. aureus is a mean LR≥6.0 CFU/carrier.

### Test Results:

Culture Purity Control: The purity of the culture was examined in each performance of efficacy tests. The growth obtained showed typical colony morphology and colony color (small, circular, golden-colored, or white) with no evidence for contamination.

Sterility Controls: All sterility controls were found to be negative.

Efficacy Test: The numbers of CFU for three test carriers are shown in Table 4a. for the test substance Green Biocide #1 & Green Biocide #2. The number of CFU in three different dilutions in three control carriers are shown in Table 4b. LD values were calculated using a validated Excel sheet.

The results show that all the achieved mean test LD were above 6.0 and no colony was observed in test carriers for Green Biocide #1 & Green Biocide #2, which confirmed validity of the efficacy test.

The log 10 reductions and percentage reduction were calculated using a validated excel sheet. Results are summarized in Table 5. The log 10 reduction for Green Biocide #1 & Green Biocide #2 at 10-minute and 5-minute contact time was 6.35.

Based on the acceptance criterion of >6 log 10 in the CFU for bactericidal activity, all three lots of the test sample passed.

Table 4: Results of Efficacy Test Using S. aureus, for Test Item Green Biocide #1 and Green Biocide #2 at Two Different Contact Times (5 Minute and 10 Minute).

TABLE 4a
CFU of S. aureus, for the test

| Test Substance | Contact Time | | Sample ID | 10⁰ | 10⁻¹ | 10⁻² | 10⁻³ | 10⁻⁴ |
|---|---|---|---|---|---|---|---|---|
| Green Biocide #1 | 5 | min | T1 | 0 | 0 | 0 | 0 | 0 |
| | | | T2 | 0 | 0 | 0 | 0 | 0 |
| | | | T3 | 0 | 0 | 0 | 0 | 0 |
| | 10 | min | T4 | 0 | 0 | 0 | 0 | 0 |
| | | | T5 | 0 | 0 | 0 | 0 | 0 |
| | | | T6 | 0 | 0 | 0 | 0 | 0 |
| Green Biocide #1 | 5 | min | T7 | 0 | 0 | 0 | 0 | 0 |
| | | | T8 | 0 | 0 | 0 | 0 | 0 |
| | | | T9 | 0 | 0 | 0 | 0 | 0 |
| | 10 | min | T10 | 0 | 0 | 0 | 0 | 0 |
| | | | T11 | 0 | 0 | 0 | 0 | 0 |
| | | | T12 | 0 | 0 | 0 | 0 | 0 |

TABLE 4b
CFU of S. aureus, for each dilution of the control.

| | | | | | Average |
|---|---|---|---|---|---|
| | | | | Log₁₀ | Log₁₀ |
| Sample ID | 10⁻⁴ | 10⁻⁵ | 10⁻⁶ | Density | Density |
| C1 | TNTC | 47 | 9 | 6.36 | 6.35 |
| C2 | TNTC | 42 | 2 | 6.34 | |
| C3 | TNTC | 37 | 5 | 6.34 | |

TABLE 5
Log10 reductions and % reductions using S. aureus, for
Test item Green Biocide #1 & Green Biocide #2

| | | | Log₁₀ | |
|---|---|---|---|---|
| Sample ID | Contact Time | | Reduction | % Reduction |
| Green Biocide #1 | 5 | minutes | 6.35 | 99.99996 |
| | 10 | minutes | 6.35 | 99.99996 |
| Green Biocide #2 | 5 | minutes | 6.35 | 99.99996 |
| | 10 | minutes | 6.35 | 99.99996 |

Conclusion: Under the test conditions specified in the protocol, the test substance Green Biocide #1 & Green Biocide #2 met the acceptance criterion as required by Health Canada and the U.S. EPA. The performance standard for S. aureus is >6 log reduction. Based on the acceptance criterion, the two test sample passed at 5-minute and 10-minute contact time. There were no circumstances that may have adversely affected the quality or integrity of the data.

The below graphs depict the results of an antimicrobial activity test conducted under ASTME standards 2180:2007 using 2 different bacterial strains Staphylococcus aureus (Gram positive) and Pseudomonas (Gram negative) as well as yeast and fungi, respectively, Aspergillus brasiliensis and Candida albicans. For each test strain specimens of treated material and also of untreated (negative control) are used. Each test specimen was placed into a separate sterile Petri plate and the inner surface of test material was inoculated with 1 ml of the test suspensions in agar slurry.

The biocidal agent was used in 2 different dilutions (1:10 and 1:1000) of its initial concentration for logarithmic calculations. Immediately after inoculum (T0), specimens of untreated and treated material were processed in a time course manner (5 and 10 min) by adding neutralizer in order to remove microorganism, and agitated mechanically for 2 minutes.

The viable microbial count was performed by inclusion in Agar Medium, by seeing 1 ml twice of previously prepared solution and 1 ml twice of 10-fold serial dilutions in neutralizer as we mentioned earlier. The remaining specimens were incubated at 37 degrees celsius for 24 to 48 h.

### Knock Down %:

| | Initial | 5 min | 5 min | 10 min | 10 min |
|---|---|---|---|---|---|
| | Spike | Interval | Interval | Interval | Interval |
| | Time | | | | |
| | 0 | 5 | 5 | 10 | 10 |
| | Inoculum Dilution Rate | | | | |
| | cfu/mL | 1:10 | 1:1000 | 1:10 | 1:1000 |
| Aspergillus | 178000 | 1330 | 15000 | 840 | 18000 |
| brasiliensis | | | | | |
| ATCC 16404 | | | | | |
| Candida | 180000 | 1 | 2000 | 10 | 3000 |
| albicans | | | | | |
| ATCC 10231 | | | | | |
| Escherichia | 12600000 | 1 | 1 | 1 | 1 |
| coli | | | | | |
| ATCC 8739 | | | | | |
| Pseudomonas | 9700000 | 1 | 1 | 1 | 1 |
| aeruginosa | | | | | |
| ATCC 9021 | | | | | |
| Staphylococcus | 11300000 | 1 | 1 | 1 | 1 |
| aureus | | | | | |
| ATCC 6538 | | | | | |

| | Initial | 5 min | 5 min | 10 min | 10 min |
|---|---|---|---|---|---|
| | Spike | Interval | Interval | Interval | Interval |
| | Time | | | | |
| | 0 | 5 | 5 | 10 | 10 |
| | Inoculum Dilution Rate | | | | |
| | cfu/mL | 1:10 | 1:1000 | 1:10 | 1:1000 |
| Aspergillus | 100 | 99.25 | 91.57 | 99.53 | 89.89 |
| brasiliensis | | | | | |
| ATCC 16404 | | | | | |
| Candida | 100 | 100.00 | 98.89 | 99.99 | 98.33 |
| albicans | | | | | |
| ATCC 10231 | | | | | |
| Escherichia | 100 | 100.00 | 100.00 | 100.00 | 100.00 |
| coli | | | | | |
| ATCC 8739 | | | | | |
| Pseudomonas | 100 | 100.00 | 100.00 | 100.00 | 100.00 |
| aeruginosa | | | | | |
| ATCC 9021 | | | | | |
| Staphylococcus | 100 | 100.00 | 100.00 | 100.00 | 100.00 |
| aureus | | | | | |
| ATCC 6538 | | | | | |

Although the above disclosure has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments. In addition, while a particular feature may have been described above with respect to only one or more of several illustrated embodiments, such feature may be combined with one or more other features of the other embodiments, as may be desired and advantageous for any given or particular application.

1. A biocidal agent comprising:
a natural oil-derived aliphatic fatty-acid chain;
at least one quaternary ammonium salt moiety at one end of the natural oil-derived aliphatic fatty-acid chain; and
a non-ionic surfactant bonded to each of the at least one quaternary ammonium salt moiety to form a liphophilic core with polar extremities to form a self-emulsified water soluble biocidal agent.

2. The biocidal agent according to claim 1, wherein the non-ionic surfactant includes 6 to 8 moles of ethylene oxide.

3. The biocidal agent according to claim 1, wherein the natural oil-derived aliphatic fatty-acid chain is a soybean oil-based aliphatic fatty-acid chain.

4. The biocidal agent according to claim 1, wherein the wherein the natural oil-derived aliphatic fatty-acid chain is a canola oil-based aliphatic fatty-acid chain.

5. A biocidal agent comprising:
a soybean oil-derived aliphatic fatty-acid chain;
at least one quaternary ammonium salt moiety at one end of the soybean oil-derived aliphatic fatty-acid chain; and
a non-ionic surfactant bonded to each of the at least one quaternary ammonium salt moiety to form a liphophilic core with polar extremities to form a self-emulsified water soluble biocidal agent.

6. The biocidal agent according to claim 5, wherein the non-ionic surfactant includes 6 moles of ethylene oxide.

7. A method of producing a biocidal agent, the method comprising the steps of:
providing a functionalized natural oil-derived fatty acid derivative;
providing at least one quaternary ammonium salt moiety and at least one siloxane moiety on a functional group of the functionalized natural oil-derived fatty acid derivative;
binding a non-ionic surfactant to each of the at least one quaternary ammonium salt moiety to form a lipophilic core with polar extremities to form a water soluble biocidal agent,
wherein carboxylic groups of the natural oil-derived fatty acid derivative remain intact.

8. The method according to claim 7, wherein the providing a functionalized natural oil-derived fatty acid derivative includes providing a natural oil-derived fatty acid and functionalizing the natural oil-derived fatty acid.

9. The method according to claim 8, wherein the natural oil-derived fatty acid is derived from soybean oil.

10. The method according to claim 9, wherein the natural oil-derived fatty acid is derived by epoxidizing the soybean oil.

11. The method according to claim 8, wherein the functionalizing the natural oil-derived fatty acid derivative includes at least one of amidation and transesterification.

12. The method according to claim 7, wherein the method further includes solubilizing the biocidal agent in water.

13. A method of producing a biocidal agent, the method comprising the steps of:
providing a functionalized natural oil-derived fatty acid derivative;
providing at least one quaternary ammonium salt moiety and at least one siloxane moiety on a functional group of an aliphatic chain of the functionalized natural oil-derived fatty acid derivative;
binding a non-ionic surfactant to each of the at least one quaternary ammonium salt moiety to form a lipophilic core with polar extremities to form a water soluble biocidal agent.
